(19) United States
(12) Patent Application Publication
(10) Pub. No.: US 2012/0290344 A1
(43) Pub. Date: Nov. 15, 2012

(54) METHOD FOR DETERMINING EMISSIONS OF GREENHOUSE GASES (GHG) IN THE PRODUCTION OF BIOPRODUCTS

(75) Inventors: Ricardo ARJONA ANTOLIN, Sevilla (ES); María de las Nieves VALENZUELA ROMERO, Sevilla (ES); Beatriz ALONSO MARTINEZ, Madrid (ES); Raquel DIAZ MOLIST, Madrid (ES); Rocío GARCIA ENCINAS, Sevilla (ES); Maria Angeles GUTIERREZ MONTERO, Sevilla (ES); Jesús YAÑEZ VIDAL, Sevilla (ES); Laura MONTES GARCIA, Sevilla (ES); Jesús LOPEZ LOPEZ, Sevilla (ES); Macarena MARQUEZ PINUELA, Sevilla (ES); Marta VAZQUEZ GARCIA, Sarriguren (ES)

(73) Assignee: ABENGOA BIOENERGIA NUEVAS TECNOLOGIAS, S.A., Sevilla (ES)

(21) Appl. No.: 13/467,216

(22) Filed: May 9, 2012

Related U.S. Application Data
(63) Continuation-in-part of application No. 13/103,331, filed on May 9, 2011.
Application No. 13/103,331 is a continuation-in-part of application No. 13/103,403, filed on May 9, 2011.

(51) Int. Cl. G06F 19/00; G06Q 10/00

(52) U.S. Cl. 705/7.11; 702/24; 702/2

(57) ABSTRACT

A method for quickly and remotely GHG emissions without providing the sources of raw material production means to collect parameters is disclosed. The method uses a processing unit for executing instructions related to the determination of emissions, a database to store relevant parameters related to the production of raw materials, means of transmission of data to recover the parameters of the database and transmit these parameters to the processing unit, and a modeling module of GHG emissions connected to the processing unit and adapted to generate a level of GHG emissions. The method comprises considering a partial estimate for emissions in relation to any process and an add value for such global GHG emissions.

### CROSS-REFERENCE TO RELATED APPLICATIONS

This application is a continuation-in-part of U.S. Non-Provisional patent application Ser. Nos. 13/103,331 and 13/103,403, both filed May 9, 2011, which are hereby incorporated herein by reference in their entireties for all purposes.

### OBJECT OF THE INVENTION

The invention described herein relates to the field of sustainability and environmental control in the production of raw materials and further processing for the production of bioproducts.

The object of the invention is a system and method for producing bio-products from different raw materials control at all times the value of emissions of greenhouse gas (GHG) produced in all the processes needed to convert these raw materials in bioproducts.

### BACKGROUND OF THE INVENTION

The bioproducts include building materials, pulp and paper, forest products, biofuels, bioenergy, bioethanol based on cellulose and starch-based, adhesives based on biological, biochemical, bioplastics, biodiesel, butanol, biogas, chemicals, etc.. The bioproducts are active subjects of research and development, and these efforts have developed significantly in the transition Century 20/21, driven mainly by the environmental impact of oil use. The bio-derived bioproducts can replace many of the fuels, chemicals, plastics, etc, currently derived from petroleum.

For example, as a form of bioproduct, bioenergy is renewable energy made available from materials derived from biological sources and include different forms, such as biofuels, bioliquids, biogas, renewable electricity and renewable heat. In a narrower sense is a synonym for biodiesel, a fuel derived from biological sources. In a broader sense includes biomass, the biological material used as biofuel, as well as social fields, economic, scientific and technical associated with using biological sources of energy. Bioproduct means renewable energy derived from biological materials, including: biofuels, bioliquids, biogas, renewable electricity and renewable heat.

As an example of bioproduct, biofuels have attracted the attention of scientists and the general public, influenced by factors such as increasing oil prices, the need for increased energy security, and concerns about emissions of greenhouse gases fossil fuels. Biofuels are used inter alia for the production of ETBE (gasoline additive), or for direct blending with gasoline or diesel. As renewable energy sources, biofuels reduce CO2 emissions and contribute to the security and diversification of energy supply, while reducing dependence on fossil fuels in transportation and help in implementing the Kyoto Protocol.

Somehow it seems clear that the use of raw materials to produce a bioproduct is an alternative to the use of other fossil fuels and produce fewer greenhouse gases, but you need to ensure that total emissions in relation to such bio does not exceed the emissions related to fossil fuels.

Most GHG emissions related to bioproducts can be associated with the production processes of raw materials for these bioproducts. Therefore it is necessary to focus on reducing GHG emissions related to these processes for the production of raw materials.

Get on the origins of production of such materials relevant parameters for GHG emissions related to production of raw materials is usually not possible due to the large amount of time and resources must be consumed to meet those parameters.

Therefore, there is a need to calculate quickly and remotely GHG emissions in the production of raw materials, without giving the sources of production means for the parameters. GHG emissions should be aware of before deciding to buy these materials.

### DESCRIPTION OF THE INVENTION

The invention relates to a method for determining GHG emissions involved in the various processes and stages of production, in particular source of raw material to obtain a bioproduct which can in turn comprise a coproduct. The specific purpose of this invention is to describe the production of GHG emissions associated with production processes of raw materials to obtain a form of bioproduct.
Comprising bioenergy Bioproducts, as well as similar products bioplastics, butanol, furfural, app, apg, fumaric acid, acetic acid, lactic acid, xylitol, pha, sorbitol, itaconic acid, adipic acid, 1,4-butanediol, 1,3-propanediol, succinic acid, acrylic resins, carbon fiber, phenol or quinone, among others. A form of bioenergy can be biofuels, such as bioethanol or biodiesel, or can be biogas, bioliquids, renewable electricity or renewable thermal energy, among others.

Following are some definitions that correspond to some terms to be used later. Processing unit means any device (eg a computer) adapted to receive/retrieve data from databases or storage media (such as memory readable), perform calculations and send the results of calculations media output (screen, printer, etc.)

Calculated parameter: parameter that can be obtained from another. Reference values: values obtained from databases and literature data for the same product or process related. Activity data: a characteristic parameter of the activity or the means used to perform each process, which allows to determine emissions for a given period by calculating. Emission Factor: A parameter that indicates the amount of GHG emitted directly or indirectly including from a particular process by a unit of activity data. Emission value, a parameter that indicates the amount of GHG emitted directly or indirectly, including for each process calculated using the processing unit and/or emissions modeling module for each process. Emission level covering all emission values associated with all the necessary processes to transform the source material in bioproduct. According to a first aspect of the object of the invention herein described, the invention relates to the controlled production of bioproducts which includes monitoring and calculation of emissions of greenhouse gases (GHGs) in the feedstock production and subsequent conversion of these materials to obtain a bioproduct.

For the embodiment of the invention there is provided a system having at least one processing unit adapted to execute instructions related to control of the necessary processes to carry out the processing of raw materials while bioproducts is responsible for the determination of GHG emissions in the production of such raw materials for bioproducts; at least one database, accessible by at least one processing unit is used to store data such as relevant parameters related to processes for producing both raw materials for the processing of these same in bioproducts, while the said processing unit and the database connected by data transmission media capable of transmitting data between said parts of the system processing. The system has to carry out necessary tasks of the method object of the invention of a modeling module GHG incorporated in the form of a computer program executable by the processing unit, when starting up the said module is started capture data for the generation levels of GHG emissions produced in the processes required to produce the raw materials and their subsequent conversion into bioproducts, such data is sent and stored in the database will be accessible to the unit processing by means of data transmission, and therefore to the modeling module of greenhouse gas emissions. For a better access to the database, and for safety reasons, it is anticipated that the database is located on storage media accessible by the processing unit, means being local or remote storage and supported in any digital storage such as magnetic or optical. The data and/or parameters detected are always related to GHG emissions, or other data if it becomes necessary as. temperature, pressure, amount of fertilizer, . . . This means are provided for data capture in each and every one of the processes and stages required to produce bioproducts. It is preferred that the relevant parameters comprise parameters retrieved, mediated by means of data capture, from storage means, said storage means storing information related to the production of raw materials and bioproducts for further processing in these bioproducts.

Preferably, the processing unit comprising: at least one processor adapted to process at least GHG emission parameters, at least one processor connected to memory, and storage media accessible by the processing unit and adapted to store at least some instructions related with the process of at least the parameters of emission gas emissions. The means of data transmission is preferably selected from the group consisting of: media wired, wireless media and means of near field communication. The database may preferably further comprise at least one quality index that is associated with at least one of the relevant parameters. This quality index indicates the reliability of the parameter to which it refers. The lower the quality index, the higher the reliability of the parameter.

The database can be located preferably on a server accessible by the modeling module of GHG emissions and/or processing unit. Alternatively, the database can be located in the storage means. The production of raw materials for the production of bioproducts from them are varied, as cereals, sugar cane, straw, energy crops, forestry equipment, forestry residues, organic waste, alcohol, wine, fisheries and aquaculture waste and oilseeds. All these cultures have different production processes, including: procedures for extraction and cultivation of raw materials, processes for the collection of raw materials, processes for waste treatment and waste of raw materials and processes for the production of chemicals or products used in the extraction and cultivation of raw materials. Once the relevant data captured and sent to the database, we proceed to recover the database using the modeling module of GHG emissions, using instructions from the processing unit, relevant parameters in relation to:
Procedures for the Collection and cultivation of raw materials.
Processes for collecting raw materials.
Treatment of waste and waste materials.
Production of chemicals or products used in the extraction and cultivation of raw materials.
Generating own energy consumption: production plants can be differentiated into two types based on the existence of power generation facilities owned or not,
Processes of conversion of bioproducts: along with the products needed to convert matter into bio-products are identified and their common processes such as pre-separation of the product and coproduct.
Processes for bioproduct coproducts: This stage should be considered when associated with the processes needed to obtain the coproduct of the production of bioproducts in the conditions of sale required (as granules and with a defined moisture).

Once collected all these data are processed by the processing unit said parameters relevant in relation to each process involved in the processes of production of both commodities as the bioproduct from them to calculate values of partial GHG emissions with respect to each process, to add those values to calculate a partial general level of GHG emissions.

The processing parameters comprises multiplying a relevant activity data for emission factor, activity data being a parameter characteristic of the activity or the means used to perform each process, which allows to determine emissions for a given period through the calculation, and the emission factor being a parameter that indicates the amount of direct GHG emitted from a particular process per unit of activity data. Preferably the activity data for a process can be composed of a combination of various parameters and factors constant. Thus, generally and for each process with its consequent tasks which in turn can be divided into subtasks that are available generally GHG emissions associated with both the production of bioproduct has both procurement processes as processes conversion, and the partial emission values can be calculated according to the following formula for each process necessary for the generation of the raw material necessary for each process in the processing thereof in bioproduct:

Emission Value=Emission Factor•Activity Data

So that finally generates an emission level that encompasses all emission values associated with all the necessary processes. This is accomplished by applying the following formula:

Emissions=Σ(Activity Dataᵢ.Emission Factorᵢ)+Σ(TDERᵢ) i=1
for “n” stages, tasks, subtasks and/or processes previously identified:

In which:—The activity data are a characteristic parameter of the activity or the work of equipment, facilities, processes or vehicles associated with a given source, which determines their emissions for a given period through calculations. Examples of activity data are fuel consumption, consumption of raw materials, the distance covered by vehicles, etc.. The value of each of the activity data can vary in each production, the origin of matter primary the case of use of the defined type of feedstock. Activity data resulting for a defined subtask may be composed of a combination of various parameters and factors constant. These values of activity data are available in different forms, and is the result of different calculations manipulate one or more variables related to emissions of GHG (greenhouse gas) generated from each process used for the production of bioproducts collected from a plurality of sensors arranged along the various devices used in the various processes required data or from databases or information systems.

The emission factor is a parameter that indicates the amount of a particular pollutant emitted from a particular activity per unit of product, volume, duration, quantity of raw material or fuel etc., And that is by the unity of what has been designated “activity data”. The value of each emission factor may vary in each production facility, the source of raw material and use case defined type of raw material. This emission factor value can be obtained in different ways, and is the result of manipulation (by different estimates) one or more variables related to GHG emissions (greenhouse gas) generated from each process used to produce bioproducts.

It is worth mentioning that both activity data and emission factor can be calculated from the same variables, or it is practicable to estimate the values of the activity data of one or more variables and the emission factor of one or more variable than those used to calculate the activity data and additionally when using more than one variable to calculate the emission factor or activity data, is because of these variables is used to calculate the activity data and the emission factor.

Therefore the method and system described here based on the production of raw material to be processed into bioproduct(s) is preferred that the extraction processes and growing raw materials including at least one process selected from: tillage the earth, making seeds, planting, irrigation, fertilizer application, pesticide application, direct and indirect emissions of NO2 soil and organic fertilizers. The system object of the invention has means to capture data relating to the emissions generated in each of these processes, data which are used both by the system as by the method of the invention for recovery and processing once captured and held in the database. As relevant data to consider and that are caught and sent to the database include:
Parameters relevant to the energy consumption during the plowing operation.
relevant parameters related to the amount of production of seeds.
Parameters relevant to the energy consumption of a machine for cultivation.
Parameters relevant to the energy consumed in pumping water for irrigation.
Parameters relevant to energy consumption in the fertilizer application.
Parameters relevant to the energy consumption for applying pesticides.
Parameters relevant to the direct and indirect emissions of N2O: these emissions are associated with emissions of nitrous oxide from soil due to direct emissions of nitrogen, as well as leaching and volatilization of nitrogen.
Parameters relevant to the emissions associated with the application of organic fertilizers: these emissions are associated with the replacement of inorganic fertilizer based on nitrogen. Since processes for the collection of raw materials comprising at least one process selected from: harvesting raw materials, transportation of raw materials within the plot, transportation of raw materials to storage of raw materials; storage raw materials, and drying the raw materials.

Therefore included in the above:
Parameters relevant to the energy consumption of machinery for harvesting.
Parameters relevant to the energy consumption of a transport medium for the transport of the raw materials within the parcel.
Parameters relevant to the energy consumption of a conveyance for transporting raw materials from the site original storage of raw materials harvested.
Parameters relevant to the energy consumption in relation to the loading and unloading of the raw materials within the storage area and maintaining said controlled conditions in storage.
Parameters relevant to energy consumption and/or fuel in the drying of raw materials.

Also since the processes for treating waste and waste materials reach raking, packing, collecting and transporting bales bales, etc.. is added to the above:
Parameters relevant to the energy consumption of a machine rake.
Parameters relevant to the energy consumption of a packaging machine.
Parameters relevant to the energy consumption of a machine to collect bales.
Parameters relevant to the energy consumption of a machine for transporting such bales to a storage of bales.

Preferably, the processes for the production of chemicals or products used in the extraction and growing raw materials comprising at least one process selected from: manufacture of fertilizers and pesticides manufacturing. The data recovery stage may comprise at least one action selected from:
Recover the database using the modeling module of GHG emissions, using instructions from the processing unit, relevant parameters related to the composition and quantity of fertilizer used, and—Recover the database using the modeling module of GHG emissions, using instructions from the processing unit, relevant parameters related to the composition and quantity of pesticide used. Factor partial GHG associated with the manufacture of fertilizer can be calculated as a preferably weighted average emission factor for each type of fertilizer according to the amount used in each geographical area. The amount of fertilizer used (ie the factor of activity) can be estimated from parameters that relate to the global production of raw materials, global consumption of fertilizer, the fertilization ratio index theory, and the surface generally involved in the production of raw materials, therefore it is necessary to calculate, using the modeling module of GHG emissions, the amount of fertilizer used, setting the actual consumption of fertilizer with the fertilization rate theory for this is need to capture, retrieve and process:
A parameter with respect to the overall production of raw materials.
A parameter with respect to the overall consumption of fertilizer.
A parameter related to the theoretical fertilization rate indicates the amount of raw material produced per unit area.
A parameter related to the general surface involved in the production of raw materials.

Also, as previously stated, the method described herein also takes into account those bioproducts production processes involved in the production of bioproducts itself ie the transformation of the raw material into a bioproduct; processes carried out in the plant production, the first part involving the measurement of GHG emissions related to:
The creation of the own energy consumption required in the production plants to carry out the processes necessary to transform the source material bioproduct being produced in this energy in terms of electricity (partly self-consumed and exported) and CHP (combined heat and power) using steam NG (natural gas) as fuel. Also considered exhaust gas by its energy content.
The bio-conversion processes, along with the production processes needed to convert the source material in bioproducts and coproduct in common processes are identified as those prior to the preparation of the product and coproduct.

Listed as: milling, mashing, cooking, liquefaction, fermentation, distillation, dehydration, treating furnace, a cogeneration unit, gas turbine, steam turbine, preparation of raw material, biomass pretreatment, separation of solids/liquids, gasification, cooling, gas cleaning, compression, reaction catalysis, enzymatic hydrolysis, selexol, transesterification, evaporation, mixing, drying, extraction, degumming, filtration, recovery, refining, purification, clarification, acid esterification, condensation, ventilation and correction.

Additionally the method described by this process may also consider on coproducts of bioproducts when associated with those processes necessary to obtain the coproduct of the production of bioproduct in the sales conditions required (as granules and with a defined moisture). Such co-produced along with the bioproduct can be pure waste products that result to obtain as bioproduct or waste products can be some value as DDGS (Dried Distilled Grain with solubles) would need individual treatment as solid/liquid separation, evaporation, drying, pelletizing, or the co-product may have a valuable product produced with the bioproduct. In both cases produce emissions and therefore should be considered.

Different co-products may be considered, such as, inter alia: biofuels, bioliquids, biogas, chemicals, raw materials, renewable electricity, thermal energy renewable bioplastics, resins and CO2.

Different tasks are considered under the pre-defined stages, all of them are perfectly calculated and identified consumption of raw materials and energy, as well as waste generation.

Using data selected as described above for each subtask in the corresponding formula, giving the total emission value in g CO2 eq/MJ of bioproduct when the calculation is intended for bioproduct gCO2 eq/MJ or co-product when the calculation is intended for the coproduct of the bioproduct, as a result of adding all the stages involved.

The sequential computation task is always the same:
1) Selecting the appropriate subtask for each process depending on the production floor and the type of raw material.
2) Selection of relevant variables in each subtask that will be incorporated into the calculation formula. These variables cover the emission factor and activity data.
3) Execution of the calculation using the formula and the variables corresponding to each subtask.
4) The results for each subtask and the final stage in addition analyzed the individual performance of each task to its subtasks corresponding integrated.

According to a preferred embodiment of the invention, the relevant parameters stored in the database may be accompanied by a quality rating which is related to said parameters, according to predetermined criteria. The lower the quality index, the higher the reliability for the parameter value. It is anticipated that the method of the invention is subject to an improved continuous process, one or aspect of which is stored in the database with the updated parameters highest reliability available. Therefore, before storing a parameter updated, one must make a comparison between the quality index is updated parameter related to the quality and rate that is related to the current parameter, so that the updated parameter replaces stored parameter if the quality index which is related to said parameter is smaller than a current which is related to the current parameter in accordance with predetermined criteria.

The inventive method allows the determination of the value of emissions of greenhouse gases (GHG) emissions in the production of raw materials for bioproducts and in further processing, without providing the sources of production for raw materials means of collecting the relevant parameters. After storing all the relevant parameters in the database, the system of the invention can calculate the overall GHG emissions for certain raw materials related to the origin of production of certain raw materials.

### DESCRIPTION OF A PREFERRED EMBODIMENT

The object of the invention is a method for determining emissions of GHG (greenhouse gases) involved in the production of a bioproduct (that may comprise a bioplastic or butanol or any coproduct) from a raw material (i.e. cereals, sugar cane, straw, forest residues, forest materials, energy crops, organic waste alcohol, wine, fishing and aquaculture waste, waste, and oilseed crops), on a site or origin of raw materials intended for transforming this raw material into bioproduct. Later is described a preferred embodiment on the basis of raw materials to be processed into biofuel as a bioproduct particularly.

Apart from those cited above, raw materials to be processed into bioproducts like biofuel can be of various types, eg barley, wheat, corn, sorghum, sugar cane, straw, forest residues, forest materials, organic waste, alcohol, wine, fishing and aquaculture waste, and oilseed crops, as well as energy crops, among others. The production of raw materials can be located in various parts of the world.

In order to determine a total GHG emissions value generated during both the production of raw material and its transformation into bioproduct, the method hereby described initiates a capture, by means of data capture means, of data regarding GHG emissions generated by each process and operations needed to produce raw material which is intended to be transformed into bioproduct along with data regarding GHG emissions generated by every process and operation needed to transform said raw material in bioproduct. Said caption is accomplished by means of data capture sensors located along the processes needed for the production of bioproduct for, being these sensors operative to capture data related to GHG emissions produced in each process and/or by means of a data collection, collection operative to access data sources, accessible by the processing unit, where said data sources comprises data related to GHG emissions of bioproduct production processes.

Once this is data is ready and captioned is sent to a database accessible by at least one processing unit through transmission means connected to said data processing unit.

On this preferred embodiment said data may be used to calculate, amongst others, an amount of fertilizer used for the production of raw material, from data retrieved from the database, using the modeling module of GHG emissions, using instructions from the processing unit; the earlier mentioned date in this very case may comprise: a parameter related to the overall production of raw material, a parameter related to the overall consumption of fertilizer, a parameter related to the theoretical fertilization index indicating the amount of raw materials produced per unit area, or a parameter related to the general surface involved in the production of raw materials, then is possible to calculate, using the modeling module of GHG emissions, the amount of fertilizer used, adjusting the actual consumption of fertilizer with the fertilization rate theory; said amount is calculated as a weighted average emission factor for each type of fertilizer according to the amount used in each geographical area.

Once the data is allocated on the database, a modeling module of GHG emissions using instructions from the processing unit retrieve from the database, the data related to GHG emissions associated with each process and operations necessary to produce raw material transformed into bioproduct and each process and operations needed to transform the raw material into bioproduct, in order to•provide such data to the processing unit and the modeling module of GHG emissions to calculate GHG emissions from the above mentioned data through the modeling module of GHG emissions. Said data is processed by means of the modeling module of GHG and the processing unit to calculate an overall value of overall GHG emissions level from these values of partial GHG emissions in relation to each process by the sum of each partial value, using the formula:

$${Emissions}_{{operations}_{i}} = {\sum }_{i = 1}^{n} ( Activity {Data}_{i} \cdot Emissions {Factors}_{i} )$$

where: n is the number of operations in a process, activity data is a characteristic parameter of the activity or equipment, facilities, operations, processes or vehicles associated with a given source, which determines their emissions for a given period through calculation, and emission factor is a parameter that indicates the amount of direct GHG emitted from a particular activity per unit of product, volume, duration, quantity of raw materials or energy.

In alternate embodiments of the object of the invention encompass a method a computer-implemented business model data management method, useful to determine whether to use said raw material for producing a bioproduct from said raw material or for selecting an area of production of raw material to be transformed into bioproduct according to a GHG emissions level generated by the production of said raw material; and a computer program product for business object data management that allows automatically selecting an area of production of raw material to be transformed into bioproduct according to a GHG emissions level generated by the production of said raw material.

Said method identifies at least one GHG emissions level within a database structure for a business application said database comprising GHG emissions levels related to GHG emissions generated by each process and operations necessary to produce raw material to be transformed into bioproduct and every process and operation needed to transform said raw material in bioproduct. In order to accomplish the method it is required to locate data management rules (rule related to maximum GHG emissions level required by a client, rule related to a GHG emissions level generated by the production of the raw material, rule related to a GHG emissions level generated by the transformation of the raw material into bioproduct, and rule related to the value of the bioprodcut produced, wherein said value is related to a GHG emissions level generated by by each process and operations necessary to produce raw material to be transformed into bioproduct and every process and operation needed to transform said raw material into bioproduct then for said GHG emissions level in the database perform a correlation for said GHG emissions level with a business object, said business object being related to a business application associated to a bioproduct obtained from raw material, and execute said located data management rules to represent said identified business object in a database for said business application.

The computer program product for business object data management earlier mentioned is allocated on a computer useable medium having computer usable program code tangibly embodied therein and comprises computer usable program code configured to identify at least one GHG emissions level within a database structure for a business application wherein said database comprises GHG emissions levels related to GHG emissions generated by each process and operations necessary to produce raw material to be transformed into bioproduct and every process and operation needed to transform said raw material in bioproduct; to locate data management rules for said GHG emissions level in the database; and to correlate said GHG emissions level with a business object, wherein said business object is related to a business application associated to a bioproduct obtained from raw material. Obviously said computer usable program code configured to execute said located data management rules to represent said business object in a database for said business application.

In a preferred embodiment of the computer program product it embraces several rules, said rules may be related to maximum GHG emissions level required by a client, to a GHG emissions level generated by the production of the raw material, to a GHG emissions level generated by the transformation of the raw material into bioproduct, or to the value of the bioprodcut produced, wherein said value is related to a GHG emissions level generated by by each process and operations necessary to produce raw material to be transformed into bioproduct and every process and operation needed to transform said raw material into bioproduct; being the rule related to a GHG emissions level generated by the production of the raw material useful to determine whether to use said raw material for producing a bioproduct from said raw material

All of the above is directly related to both the transformation of raw material and the production of raw materials, the latter involves a number of processes which may be classified into the following groups:
Processes for the extraction and cultivation of raw materials;
Processes for the collection of raw materials;
Processes for waste treatment and waste of raw materials and
Process for the production of chemicals or products used in extraction or production of raw materials.

Each of the groups identified above processes comprises a plurality of other processes. For example:
Processes for the extraction and cultivation of raw materials include: tilling the soil, making seeds, planting, irrigation, fertilizer application, pesticide application, direct and indirect emissions of N20 from soil and organic fertilizer application;
The processes for collection and storage of raw materials include: harvesting, transportation of biomass harvested in the place of production, transportation of harvested biomass to a place of initial storage, storage of the harvested biomass, and drying of the harvested biomass.
Processes for treating waste and waste materials include: raking, baling, gathering bales, bale and transport, and transporting bales for storage.
Processes for the production of chemicals or products used in the extraction or production of raw materials includes: manufacture of fertilizers and pesticides.

### i) Emissions From the Extraction Processes and Culture.

Tillage (energy consumption). Emissions due to tillage are directly due to energy consumption. In this method, provides an average ratio for each geographic area. Emissions are calculated with an estimate of energy consumption during operation and are multiplied by the corresponding emission factor.
Manufacture of seeds. Emissions relative to the production of seeds are directly due to the amount consumed in the seed sowing process, multiplied by the emission factor for seed production.
Planting. Emissions are calculated with an estimated power consumption of equipment during operation and multiplication by the corresponding emission factor.
Irrigation. The method estimates the energy consumed in pumping water to the required pressure and multiplied by the emission factor depending on the mixture of energy in each geographical area.
Application of fertilizers. Emissions are calculated by estimating the power consumption of equipment during operation and multiplication by the corresponding emission factor.
Application of pesticides. Emissions are calculated with an estimate of energy consumption for each operation of machinery and multiplication by the corresponding emission factor.
Direct and indirect emissions of N2O: these emissions are associated with nitrous oxide emissions from soil due to direct emissions of nitrogen, as well as leaching and volatilization of nitrogen, multiplied by the corresponding emission factor.
Application of organic fertilizers: Emissions are calculated through an estimation of energy consumption for each operation of machinery and multiplying by the emission factor. Additionally these emissions are associated with the substitution of inorganic fertilizers based on nitrogen.

### ii) Emissions From the Collection of Raw Materials.

Harvested. Emissions are calculated with an estimated power consumption of the combine during operation and multiplication by the corresponding emission factor.
Transport in the field of raw materials. The method considers the transport of the raw materials within the parcel. Emissions are calculated with an estimated power consumption of the combine during operation and multiplying by the emission factor.
Transport of raw materials to storage. The method considers the emission associated with transporting raw materials from the initial storage lot where collected. Emissions are calculated with an estimate of energy consumption in the transport of raw materials and is multiplied by the corresponding emission factor.
Operation of storage. The method considers the consumption due to the daily operation in the storage (energy, gas, etc). The method considers multiplying the emission factor by an estimate of energy consumption due to loading and unloading of raw materials and internal movements of the raw materials for aeration and maintenance in controlled conditions.
Drying of raw materials. It is considered that you can use diesel, natural gas and electricity for drying of raw materials, so it is possible to select each type of energy. The method considers multiplying the energy consumption during the drying process by the emission factor.
   iii) Emissions From Waste and Residues:
Raking. The method considers a sweep of the straw which extends above the ground. GHG emissions related to energy consumption during operation, multiplied by the corresponding emission factor.
Packaging. The method considers the collection of straw bales forming and packaging which are placed on the floor. GHG emissions related to energy consumption during operation, multiplied by the corresponding emission factor.
Collection of bales. The method considers the collection of straw bales and the preparation for transport to storage. GHG emissions related to energy consumption during operation, multiplied by the corresponding emission factor.
Transportation of bales to storage. The method considers the transport from the plot to the first storage. GHG emissions related to energy consumption during operation, multiplied by the corresponding emission factor.

### iv) Emissions From the Production of Chemicals or Products Used in Mining and Farming.

Manufacture of fertilizer N, P and K. The method is based on the activity of the fertilizer and an emission factor. Emission factor for the manufacture of fertilizer are calculated as a weighted average emission factor for each type of fertilizer according to the amount used in each geographical area.
Manufacture of pesticides. The method is based on activity data of pesticides consumed from statistics, or other sources and an emission factor.

As stated above, each of the processes identified above (eg, planting or storage of raw materials) require the use of machinery and/or products/chemical reagents, as well as energy consumption and/or fuel.

Each of these processes is defined by parameters which are stored in a database where they remain available to a user. For example, a parameter would be the power consumption of a truck for sowing or consumption of energy (electricity or gas, for example) to maintain the proper temperature and humidity in a storage location.

It has a processing unit to process the parameters for calculating GHG emissions. Connecting a transmission medium to the processing unit and the database and retrieve tasks develops the parameters of the database and transmitting these parameters to the processing unit.

The processing unit calculates the emission of greenhouse gases allocated to a quantity of raw material produced in a sequence level by level as explained below: As stated above, the production of raw materials are divided into groups of processes, each of which involves some processes that can be further subdivided to define as many levels as necessary to cover all necessary actions related to the production of raw materials. The processing unit is arranged to calculate GHG emissions for each action or component in the lowest level according to the following formula:

Partial GHG Emission Value=Activity Data•Emission Factor
and then aggregated to determine a partial result for GHG emissions that relate to that level, and then add sequentially corresponding emissions at all levels until it finally obtained the global GHG emission levels corresponding to production.

For example, calculating the GHG emissions related to fertilizer production involves adding the calculation of partial GHG emissions related to production of any component of fertilizer (nitrogen, phosphorous, etc..). In a similar way emissions are calculated relative to the production of pesticides. They add so much fertilizer as the emissions of pesticides to determine the emissions associated with the processes for the production of chemicals or products used in the extraction or production of raw materials and emissions are then added with partial determined analogously to the processes for extraction and cultivation of raw materials, processes for the collection of raw materials and processes for waste treatment and waste of raw materials for a general value to those greenhouse gas emissions.

According to what stated above, GHG total emsisiones value that relates to all processes of production of raw material is calculated according to the following formula, where “i” is associated with each of the total of “n” processes, threads, operations, etc..

Total Emissions Value=Σ(Activity Dataₙ.Emission Factorₙ)+Σ(TDERᵢ) from i=1
where:
n is the number of operations in one step, in which:

Main activity: it is a characteristic parameter of the activity or equipment, facilities, processes or vehicles associated with a given source, which determines their emissions over a given period of calculation. Examples of activity data are energy consumption, consumption of raw materials, the distance covered by vehicles, etc.. The value of each of the activity data may vary due to different types of raw materials, geographic area or with the culture conditions. Resulting activity data for a defined sub-operation may consist of a combination of various parameters and factors constant.

Emission Factor: is a parameter that indicates the amount of direct GHG emitted from a particular activity per unit of product, volume, duration, quantity of raw materials or energy and so on. And that is by the unity of what has been designated as “activity data”. The value of each emission factor may vary due to different types of raw materials, geographic area or with farming operations.

It is worth mentioning that both activity data and emission factor can be calculated from the same parameters, or it may be feasible to calculate the values of activity data from one or more parameters and emission factor from one or more parameters than those used to calculate the activity data and additionally when using more than one parameter to estimate whether the emission factor or activity data, it can happen that one of those parameters used to calculate the activity data and emission factor.

The sequential calculation process or sub-operation is the same:
Selecting the appropriate sub-operation for each process depending on the source of raw material production and the type of raw materials.
Selection of parameters in each sub-operation needed to be incorporated into the calculation formula. These parameters cover both emission factors and activity data.
Implementation of the calculation using the corresponding formula and the parameters for each sub-operation.

The results for each subtask and the final results of phase analysis is obtained by adding the individual results of each task for subtask corresponding integrated.

The value for GHG emissions will be related to a value equivalent to CO2. For the purpose of calculating the equivalent value of CO2, the gases will be measured are at least one of: CO2, N2O, CH4, HFCs, PFCs and SF6.

The parameters can be displayed or not depending on the type of raw materials, as well as these parameters can in turn show or not an agency of the geographical level. This dependence of the geographical level means that the parameters show different values are determined considering whether the corresponding processes relating to different areas, for example, some parameters for harvesting may depend on whether or not seeding takes place in France and the United States.

The parameters can be determined from the production processes of raw materials can be determined by taking these parameters of the collected data such as databases and/or literature data with/without dependence on the crop. Whether or not depending on the geographical level, the parameters collected from databases and/or literature data may have different geographical area (country level, continental or global). This means that data can be collected from databases or literature relating to NUTS 3, NUTS 2, NUT 1 or administrative units corresponding to other regions outside Europe. The quality index related to the geographic scope of the literature or databases is greater the smaller the geographic scope.

As stated above, the parameter values stored in the databases are accompanied by a quality index, which gives information about the reliability of the value of said parameter, which can have different components. One such component is related to the geographical scope of the literature or database in which it has been found that parameter value. The value for that component is higher, the smaller the geographic scope. In this case, as the NUTS 3 is related to a smaller geographic scope that the NUTS 2 or country, a value for a parameter that is located in a NUTS 3 geographical reach has a lower component to the quality index related to the geographic, and therefore more reliable.

There is also a component of the quality index associated with the font type (or database literature) from which data are collected. Accordingly, data can come (in descending order of quality level, in order by increasing both the quality index component) of statistical data from official bodies, statistical sources are prestigious or technical/scientific papers. If they are not following these types of data sources for the geographic area in which it is carrying out the production of commodities for which data are being sought, then you should consider data from other geographical areas or commodities with similar agronomic conditions, which will have a major component to the quality index (low reliability).

There is also a component for the quality index that is associated with the relevant date for which data is selected. If the data come from the current year, the component to the quality index is lower (higher reliability) than that associated with the selected data from a year earlier.

As explained below, the quality index for any value of parameter has three components: (a, b, c) for level dependent geographically. The component “a” refers to the geographical level of the database and the literature in which is the parameter value. The component “b” refers to the type of power which is the value. The component “c” refers to the date for which is the value.

For various quality indices relating to the same parameter, the level of quality (and hence the reliability) is greater the smaller the first component (“a” in case of dependency, “b” in case of non-dependence geographical level). For various quality indices relating to the same parameter, which has the same value for the first component, the quality level is greater the smaller the second component. According to the above, for different levels of quality that relate to the same parameter, which has the same value for the first and second components, the quality level is greater the smaller the third component.

Providing a quality index for any value of parameter is useful for improving the reliability of GHG emission value obtained, since it allows to replace a current value for a given parameter stored in the database with a new value only if, after comparing quality indices for both values, the quality index associated with the new value allows greater reliability than that associated with the current value.

It then explains the determination of the quality of the parameters determined by taking them from the literature or databases, where the parameters show no dependence on the crop, ie the type of material considered.

First, there must be performed to identify the parameter. This means that the first task aims to identify the parameters that will be used. Parameters can be used, or emission factors.

Then, you should identify if the parameter depends on the raw material and subsequently the level of geography. (For example, the emission factor for electricity depends on the mixture of technologies used to produce it, since this depends on the geographical level, whereas it is considered that the energy consumption of the truck has no dependence on the geographical level). Then option 1 is associated with dependence and option 2 is related to the dependence not geographically.

### Option 1: Unit Geographically.

As stated above, the component that is related to the geographical level is referred to as “a”. When a geographic unit level, the most important criteria when evaluating the quality index is the geographical scope of the database or the literature of the parameter is collected. This means that when there is dependence on the geographical level “a” is the first component of the quality index. We consider three geographical levels: NUTS 3, NUTS 2, NUT 1 or administrative units corresponding to other regions outside Europe. The component “a” is set to 1 to stop a parameter value found in a database NUTS 3, NUTS 2 value of 2 and 3 for NUT value 1.

As stated above, the component that is related to the type of source is designated as “b”. When there is dependence on the geographical level, the second most important criterion when evaluating the quality index (after geographic level) is the type of source. This means that when there is dependence on the geographical level, “b” is the second component of the quality index. Four categories of sources: the statistics of government agencies, prestigious statistical sources, technical/scientific literature, and data from other regions. The component “b” has value 1 for a parameter value found in a statistic of government agencies, statistical value of 2 prestigious sources, value 3 for technical/scientific papers, and value 4 for data from other regions.

As stated above, the component that is related to the date is designated as “c”. Whether or not depending on the geographical level, the third most important criterion when evaluating the quality index (after the geographical level and type of source, or vice versa) is the type of source. This means that “c” is the third component of the quality index. Four categories of date: vintage, vintage approach, multi-year average and year available. The component “b” has value 1 for a parameter value found for the crop year, value 2 for the approximation of vintage, value 3 to the average of multiple years, and value 4 for the latest year available.

The value for any parameter is following an iterative search. Is looking through a first combination associated with the highest quality, ie quality index=(1, 1, 1). This means that you search for NUTS 3 (a=1), statistical data from official bodies (b=1) and vintage (c=1). If not found value for the parameter that has a quality score=(1, 1, 1), the search is then performed trying to find the value that is associated with the next best quality index (1, 1, 2), according to what has been explained above. Iterative search proceeds, on a reduced level of quality, until it finds a value for that parameter. The quality index associated with the successful search is given to the parameter value.

The quality index series is (1, 1, 1); (1, 1, 2); (1, 1, 3); (1, 1, 4); (1, 2, 1); (1, 2, 2); (1, 2, 3); (1, 2, 4); (1, 3, 1); (1, 3, 2); (1, 3, 3); (1, 3, 4), (2, 1, 1), (2, 1, 2), (2, 1, 3), (2, 1, 4), (2, 2, 1), (2, 2, 2); (2, 2, 3), (2, 2, 4), (2, 3, 1), (2, 3, 2), (2, 3, 3), (2, 3, 4), (3, 1, 1), (3, 1, 2), (3, 1, 3), (3, 1, 4), (3, 2, 1), (3, 2, 2), (3, 2, 3), (3, 2, 4), (3, 3, 1), (3, 3, 2), (3, 3, 3) and (3, 3, 4).

Thus, the value found for a parameter always has the best possible quality index with respect to the available data.

Option 2: When the parameter has a significant dependence of the geographical level, the most important criterion for evaluating the quality index is the font type, the second most important criterion is the geographical level and the third most important criterion is the date. This means that a search is performed iteratively, similar to that explained for Option 1, which only differs in that the components are quality index (b, a, c) instead of (a, b, c).

Continue reading to determine the quality index for the parameters determined by taking them from the literature or databases, where the parameters show dependence of the crop.

Similar to the case of non-crop dependency explained, first of all, it must identify the relevant parameter type.

Then he has to perform an iterative search similar to that explained above with cases of non-crop dependency (Option 1 and Option 2). In this case the order, for the quality index is (a, b, c).

If, after having tried to do a search for the least reliable quality index (3, 3, 4), ie the country level, and last year published reports available, there is no value, it is necessary to perform an iterative search Additional secondary, as explained below:

In the case of the secondary search, the order of the quality index is (b, a, c). Additionally, the types of sources (component “b”) are (in order): methodological assumptions, allocation of data from other geographical levels, and allocation of data from other raw materials, rather than statistics agencies, statistical data prestigious sources and published reports, respectively, as explained above.

The methodological assumption, which is associated with a value of 1 for the component “b”, involves following documented and justified assumptions to estimate the value of the parameter that considers the same raw materials and the same geographical level of the parameter involved. The allocation of data from other geographical levels is related to the value of 2 for the component “c” (For example, searching for a parameter for corn in Spain and there is no valid hypothesis for maize in Spain, the search is performed for corn in France). Rating data of other raw materials related to a value of 3 for the component “c”. (For example, wheat in Spain).

1. Method for determining emissions of greenhouse gases (GHGs) in the production of bioproduct, wherein the method comprises the steps of:
capture, by means of data capture means, data regarding GHG emissions generated by each process and operations necessary to produce raw material to be transformed into bioproduct and every process and operation needed to transform said raw material in bioproduct,
send the data captured in the previous step to a database accessible by at least one processing unit through transmission means connected to said data processing unit,
retrieve from the database, using a modeling module of GHG emissions using instructions from the processing unit the data related to GHG emissions associated with each process and operations necessary to produce raw material transformed into bioproduct and each process and operations needed to transform the raw material into bioproduct,
provide such data to the processing unit and the modeling module of GHG emissions to calculate GHG emissions from the above mentioned data through the modeling module of GHG emissions,
process by means of the modeling module of GHG and the processing unit data related to GHG emissions associated with each process and operations necessary to produce raw material transformed into bioproduct and each process and operations needed to transform the raw material into bioproduct to calculate a value of partial GHG emissions in relation to each process, using the formula:
$${Emissions}_{{operatons}_{i}} = {\sum }_{i = 1}^{n} ( Activity {Data}_{i} \cdot Emissions {Factors}_{i} )$$
where: n is the number of operations in a process, activity data is a characteristic parameter of the activity or equipment, facilities, operations, processes or vehicles associated with a given source, which determines their emissions for a given period through calculation, and emission factor is a parameter that indicates the amount of direct GHG emitted from a particular activity per unit of product, volume, duration, quantity of raw materials or energy, and
calculate an overall value of overall GHG emissions level from these values of partial GHG emissions in relation to each process by the sum of each partial value.

2. The method of claim 1 wherein the data capture means include data capture sensors located along the processes needed for the production of bioproduct for, being these sensors operative to capture data related to GHG emissions produced in each process.

3. The method of claim 1 further comprising data collection collection operative to access data sources, accessible by the processing unit, where said data sources comprises data related to GHG emissions of bioproduct production processes.

4. The method of claim 1 further comprising:
calculate an amount of fertilizer used for the production of raw material, from data retrieved from the database, using the modeling module of GHG emissions, using instructions from the processing unit, wherein said data include:
a parameter related to the overall production of raw material
a parameter related to the overall consumption of fertilizer,
a parameter related to the theoretical fertilization index indicating the amount of raw materials produced per unit area, and
a parameter related to the general surface involved in the production of raw materials,
transmit using the transmission means, the parameters calculated in the previous stages to the processing unit, and
calculate, using the modeling module of GHG emissions, the amount of fertilizer used, adjusting the actual consumption of fertilizer with the fertilization rate theory.

5. The method of claim 4 where the emission factor related to the manufacture of fertilizer is calculated as a weighted average emission factor for each type of fertilizer according to the amount used in each geographical area.

6. The method of claim 1, where the raw material is selected from at least one from the group consisting of: cereals, sugar cane, straw, forest residues, forest materials, energy crops, organic waste alcohol, wine, fishing and aquaculture waste, waste, and oilseed crops.

7. The method of claim 1, wherein the bioproduct comprises a bioplastic.

8. The method of claim 1, wherein the bioproduct comprises at least one selected from bioethanol and butanol.

9. The method of claim 1, wherein the bioproduct comprises a coproduct.

10. A computer-implemented business model data management method comprising:
identifying at least one GHG emissions level within a database structure for a business application wherein said database comprises GHG emissions levels related to GHG emissions generated by each process and operations necessary to produce raw material to be transformed into bioproduct and every process and operation needed to transform said raw material in bioproduct;
locating data management rules for said GHG emissions level in the database; and,
correlating said GHG emissions level with a business object, wherein said business object is related to a business application associated to a bioproduct obtained from raw material, and
executing said located data management rules to represent said identified business object in a database for said business application.

11. The method of claim 10 wherein the rules comprise at least one of the following rules:
rule related to maximum GHG emissions level required by a client,
rule related to a GHG emissions level generated by the production of the raw material,
rule related to a GHG emissions level generated by the transformation of the raw material into bioproduct, and
rule related to the value of the bioprodcut produced, wherein said value is related to a GHG emissions level generated by by each process and operations necessary to produce raw material to be transformed into bioproduct and every process and operation needed to transform said raw material into bioproduct.

12. The method of claim 11 wherein the rule related to a GHG emissions level generated by the production of the raw material determines whether to use said raw material for producing a bioproduct from said raw material.

13. The method of claim 11 further comprising automatically selecting an area of production of raw material to be transformed into bioproduct according to a GHG emissions level generated by the production of said raw material.

14. A computer program product for business object data management comprising a computer useable medium having computer usable program code tangibly embodied therein, the computer useable program code comprising:
computer usable program code configured to identify at least one GHG emissions level within a database structure for a business application wherein said database comprises GHG emissions levels related to GHG emissions generated by each process and operations necessary to produce raw material to be transformed into bioproduct and every process and operation needed to transform said raw material in bioproduct;
computer usable program code configured to locate data management rules for said GHG emissions level in the database; and,
computer usable program code configured to correlate said GHG emissions level with a business object, wherein said business object is related to a business application associated to a bioproduct obtained from raw material, and
computer usable program code configured to execute said located data management rules to represent said business object in a database for said business application.

15. The product of claim 14 wherein the rules comprise at least one of the following rules:
rule related to maximum GHG emissions level required by a client,
rule related to a GHG emissions level generated by the production of the raw material,
rule related to a GHG emissions level generated by the transformation of the raw material into bioproduct, and
rule related to the value of the bioprodcut produced, wherein said value is related to a GHG emissions level generated by by each process and operations necessary to produce raw material to be transformed into bioproduct and every process and operation needed to transform said raw material into bioproduct.

16. The product of claim 15 wherein the rule related to a GHG emissions level generated by the production of the raw material determines whether to use said raw material for producing a bioproduct from said raw material.

17. The product of claim 15 further comprising automatically selecting an area of production of raw material to be transformed into bioproduct according to a GHG emissions level generated by the production of said raw material.
